(19) United States
(12) Patent Application Publication
(10) Pub. No.: US 2011/0116553 A1
(43) Pub. Date: May 19, 2011

(54) Image processing device and image processing method

(75) Inventor: Takashi Kudou, Kanagawa (JP)

(73) Assignee: RENESAS ELECTRONICS CORPORATION, KAWASAKI (JP)

(21) Appl. No.: 12/926,132

(22) Filed: Oct. 27, 2010

(30) Foreign Application Priority Data
Nov. 13, 2009 (JP) 2009-260026

(51) Int. Cl. H04N 7/12

(52) U.S. Cl. 375/240.25; 375/E07.027

(57) ABSTRACT

An image processing device includes a main decoding unit that decodes chroma key of main data of input image data, a sub-decoding unit that decodes chroma key of sub-data, a pre-image combining unit that combines the decoded image data before image quality adjustment, an image quality adjusting unit that performs image quality adjustment of image data output from the main decoding unit or composite image data output from the pre-image combining unit, an image combining unit that combines image data after the image quality adjustment and image data output from the sub-decoding unit, and a path control unit that controls a data path so as to perform the image quality adjustment after combining the data when a probability that chroma key is contained in the input image data is high and to perform the image quality adjustment only on the decoded main data when the probability is low.

### INCORPORATION BY REFERENCE

This application is based upon and claims the benefit of priority from Japanese patent application No. 2009-260026, filed on Nov. 13, 2009, the disclosure of which is incorporated herein in its entirety by reference.

### BACKGROUND

1. Field of the Invention

The present invention relates to an image processing device and an image processing method for processing image data containing chroma key or luma key.

2. Description of Related Art

FIG. 4 shows the onscreen superposing device disclosed in Japanese Unexamined Patent Application Publication No. 2005-217971 (Hirata). Referring to FIG. 4, the onscreen superposing device includes an analog broadcast receiving unit 101 that receives data through an antenna 104, a scaler unit 102 that performs scaling of an output of the analog broadcast receiving unit 101, and a monitor 103 that displays the output. The analog broadcast receiving unit 101 includes a receiving unit 105, a decoding unit 120, a combining unit 112, a video format converting unit 111, an input unit 119, and an onscreen generating unit 121. The scaler unit 102 includes a scaling unit 116, an image quality adjusting unit 117, and a flag scaling unit 118.

In the onscreen superposing device, the onscreen generating unit 121 generates an onscreen signal for superimposing onscreen display on an image based on an input video signal. Further, the onscreen generating unit 121 generates an onscreen flag indicating the position of the onscreen display on the image. The combining unit 112 combines the onscreen display with the image based on the input video signal and thereby obtains a composite image. On the composite image, scaling processing is performed by the scaling unit 116 so as to fit the display area of a display means. On the other hand, the flag scaling unit 118 performs scaling processing corresponding to the scaling processing by the scaling unit 116 on the onscreen flag also. The onscreen flag after the scaling processing thereby corresponds to the display period of the onscreen display in the scaled composite image. The image quality adjusting unit 117 makes the image quality adjustment of the composite image only during the period when the onscreen flag after the scaling processing is inactive, and does not make the image quality adjustment of the composite image during the period when the onscreen flag after the scaling processing is active.

In this manner, according to the technique taught by Hirata, the onscreen display is combined with the image based on the input video signal, and the image quality adjustment is performed after the combining. Because the onscreen generating unit 121 generates the onscreen flag that indicates the position of the onscreen display on the image, the onscreen display can be recognized as a different area, thereby allowing the output of the onscreen display without making the image quality adjustment in its area.

Further, according to the technique disclosed in Japanese Unexamined Patent Application Publication No. 2006-345309 (Matsubara), a plurality of video screens are output to a video display area, and different kinds of image quality adjustment processing are performed on the respective screens. Information as to which screen each coordinate position corresponds to is output from the outside to a video display circuit and an image quality adjusting circuit. Because the combining of the onscreen with the image is performed after carrying out the image quality adjustment, the image quality of the onscreen is not adjusted.

### SUMMARY

However, in the technique taught by Hirata, even when video data treated as a still image (which is referred to hereinafter as a sub-video) is contained, all video data is processed in the same way, and the image quality adjustment is performed on the whole area.

Chroma keying or chroma key compositing is a technique for making a part of a video transparent using a specific color component and combining another video therewith. In the case of inputting the image data containing chroma key to the device disclosed in Hirata, a decoder for the sub-video is added, and the sub-video and the main video are combined by the combining unit 112, for example. In this case, however, there is a problem that the image quality adjustment is always performed on the sub-video even when it is inappropriate to carry out the image quality adjustment on the sub-video. Note that the technique taught by Matsubara is not compatible with the image data containing chroma key.

A first exemplary aspect of the present invention is an image processing device which includes a main decoding unit that receives main data of input image data and decodes chroma key or luma key, a sub-decoding unit that receives sub-data of the input image data and decodes chroma key or luma key, a pre-image combining unit that combines image data decoded by the main decoding unit and the sub-decoding unit before image quality adjustment, an image quality adjusting unit that performs image quality adjustment of image data output from the main decoding unit and composite image data output from the pre-image combining unit, an image combining unit that combines image data after the image quality adjustment and image data output from the sub-decoding unit, and a path control unit that controls a path of data so as to perform the image quality adjustment after combining the decoded main data and the decoded sub-data when there is a high probability that chroma key or luma key is contained in the input image data and to perform the image quality adjustment only on the decoded main data when there is a low probability that chroma key or luma key is contained in the input image data.

A second exemplary aspect of the present invention is an image processing method which includes receiving main data and sub-data of input image data, decoding chroma key or luma key of the main data and the sub-data, and performing image quality adjustment after combining the decoded main data and the decoded sub-data when there is a high probability that chroma key or luma key is contained in the input image data, and performing the image quality adjustment only on the main data of the input image data when there is a low probability that chroma key or luma key is contained in the input image data.

According to the exemplary aspects of the present invention, when there is a high probability that chroma key or luma key is contained in the input image data, the image quality adjustment is performed after combining the main data and the sub-data, thereby conducting the same image quality adjustment processing on the main data and the sub-data. On the other hand, when there is a low probability that chroma key or luma key is contained in the input image data, the image quality adjustment is performed only on the main data, thereby making the image quality adjustment of only the main data without making the image quality adjustment of the sub-data.

According to the exemplary aspects of the present invention described above, it is possible to provide an image processing device and an image processing method capable of performing appropriate image processing on image data containing chroma key or luma key.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a view showing an image processing device according to an exemplary embodiment of the present invention;

FIG. 2 is a view showing an operation of an image processing device according to an exemplary embodiment of the present invention in a case of performing image quality adjustment of main video data before combining with sub-video data;

FIG. 3 is a view showing an operation of an image processing device according to an exemplary embodiment of the present invention in a case of performing image quality adjustment of main video data after combining with sub-video data; and

FIG. 4 shows an onscreen superposing device disclosed in Hirata.

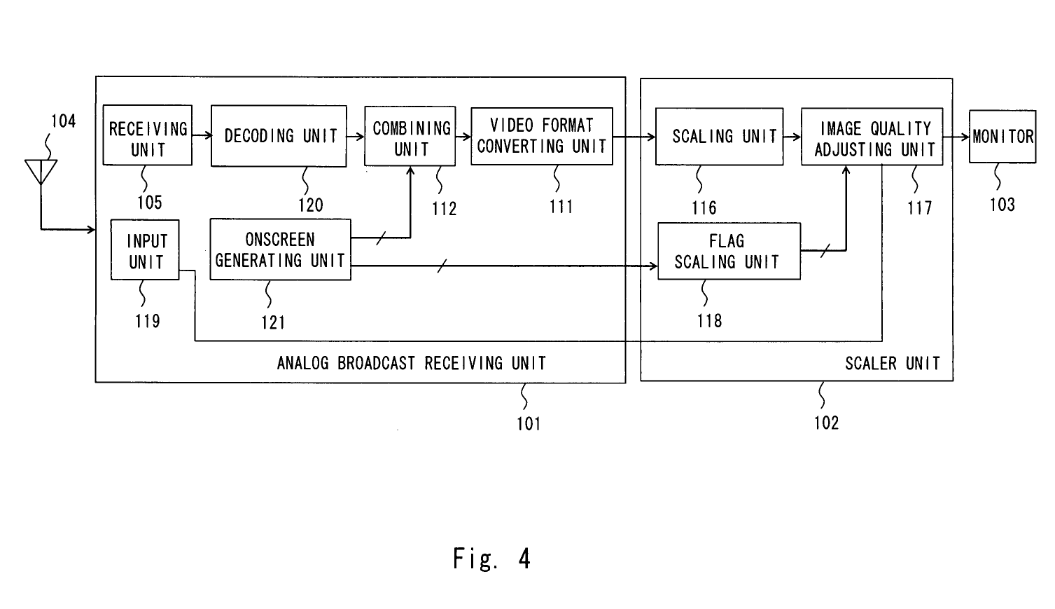

### DETAILED DESCRIPTION OF THE EXEMPLARY EMBODIMENTS

An exemplary embodiment of the present invention is described hereinafter in detail with reference to the drawings. In the exemplary embodiment, the present invention is applied to an image processing device and an image processing method capable of performing appropriate image processing on data containing chroma key, such as data of a DVD (Digital Versatile Disc) or a Blu-ray disc.

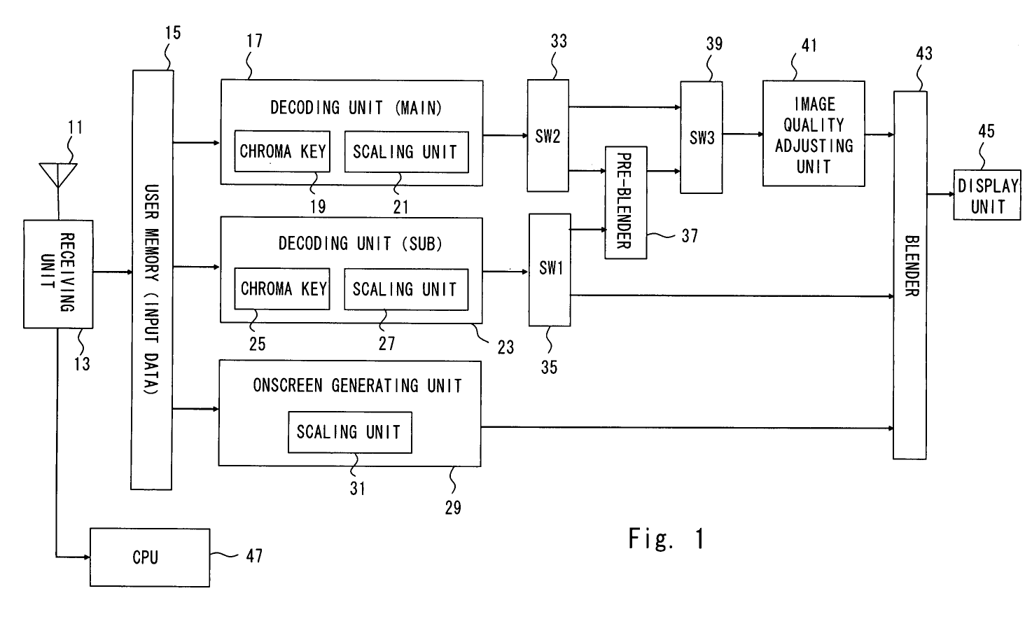

FIG. 1 is a view showing an image processing device according to an exemplary embodiment of the present invention. The image processing device includes a main decoding unit 17, a sub-decoding unit 23, a pre-image combining unit (pre-blender) 37, an image quality adjusting unit 41, an image combining unit (blender) 43, and a path control unit (not shown).

The main decoding unit 17 decodes chroma key contained in main video data of input image data. The sub-decoding unit 23 decodes chroma key contained in sub-video data of the input image data. The pre-image combining unit 37 combines the image data decoded by the main decoding unit 17 and the sub-decoding unit 23 before image quality adjustment. The image quality adjusting unit 41 performs image quality adjustment of the image data output from the main decoding unit 17 and the composite image data output from the pre-image combining unit 37. The image combining unit 43 combines the image data after the image quality adjustment and the image data output from the sub-decoding unit 23.

The path control unit controls the path of data so as to perform the image quality adjustment after combining the decoded main video data and sub-video data when there is a high probability that chroma key is contained in the input image data, and to perform the image quality adjustment only on the decoded main video data when there is a low probability that chroma key is contained in the input image data.

The image processing device can thus perform the image quality adjustment after combining the main video data and the sub-video data when the input image data is a content that contains chroma key (luma key), and perform the image quality adjustment only on the main video data when the input image data is a content that does not contain chroma key (luma key). Further, the image processing device does not perform the image quality adjustment all the time. Therefore, the image processing device according to the exemplary embodiment decides whether or not to supply the output of the main decoding unit 17 to the pre-image combining unit 37 by the pre-image combining unit 37 and the path control unit, and includes the image quality adjusting unit 41 between the pre-image combining unit 37 and the image combining unit 43. The image processing device that performs the image quality adjustment only when necessary is thereby implemented at low cost. Although a case where the content contains chroma key is described by way of illustration in the following description, the same applies in the case of luma key.

The image processing device according to the exemplary embodiment is described hereinafter in further detail. The image processing device according to the exemplary embodiment further includes a receiving unit 13 that receives data through an antenna unit 11, a user memory 15 that stores the data received by the receiving unit 13, an onscreen generating unit 29, a CPU (Central Processing Unit) 47 that controls the path control unit or the like, and a display unit 45 that displays the image data combined by the image combining unit 43.

The receiving unit 13 generates main video data and sub-video data from the received data and stores them into a given region of the user memory 15. The timing when the receiving unit 13 writes the received data into the user memory 15, the timing when the main decoding unit 17, the sub-decoding unit 23 and the onscreen generating unit 29 read data from the user memory 15 or the like is controlled by the CPU 47. Further, the receiving unit 13 writes the main video data, the sub-video data, and onscreen data which are contained in the input image data into a given region of the user memory 15. The main decoding unit 17 includes a chroma key decoding unit 19 and a scaling unit 21, and performs chroma key decoding of video data by the chroma key decoding unit 19 and performs scaling to fit the size of the display unit 45 by the scaling unit 21. Note that the main decoding unit 17 may perform the chroma key decoding after the scaling.

The chroma key decoding unit 19 reads the main video data from the given region of the user memory 15. The main video data is a main image, which is typically a moving image. Further, the main video data is made up of data that does not contain the definition of transparency. The chroma key decoding unit 19 performs decoding for creating a transparent area on the image data. The input image data read from the user memory 15 is image data in Y, Cb, Cr format, and output data is image data in Y, Cb, Cr format having a (transparency). Thus, in the case of video data containing chroma key or luma key, image data which is displayed non-transparent (or semi-transparent) except for a part that is made transparent by chroma key or luma key is generated.

For example, in the case where data with Y=10, Cb=10, Cr=10 is defined as chroma key, only the data part of Y=10, Cb=10, Cr=10 has transparent α, and all of the other combinations of Y/Cb/Cr have non-transparent a so that they are output without becoming transparent. Chroma key is typically set outside the range of Y/Cb/Cr defined by the specifications (the region which is not used when displaying normal colors).

The sub-decoding unit 23 also includes a chroma key decoding unit 25 and a scaling unit 27, and decodes chroma key or luma key by the chroma key decoding unit 25 and then performs scaling by the scaling unit 27. Note that the sub-decoding unit 23 may perform the chroma key or luma key decoding after the scaling. The chroma key decoding unit 25 reads the sub-video data from the given region of the user memory 15 and performs decoding of chroma key or luma key of the read data.

The sub-video data is a sub-image, and it is a background image. The sub-video data is typically a still image, though it is a moving image in some cases. Further, the sub-video data is data that does not contain the definition of transparency, just like the main video data. For example, in the case of digital terrestrial broadcasting, the sub-video data is still image data that does not contain chroma key, and in the case of DVD data and data from a Blu-ray disc (BD), the sub-video data is a moving image or video data treated as a still image. Note that the video data of a still image means a still image having the identical data format and structure to a moving image.

The onscreen generating unit 29 generates an onscreen signal from the input image data and outputs the generated onscreen signal to the image combining unit. The onscreen signal enables display of character information, graphic information, caption information and so on. The onscreen generating unit 29 reads the onscreen data from a given region of the user memory 15 and outputs image data in Y, Cb, Cr format, for example, to the image combining unit. The image data is data having individual transparency for each pixel. The onscreen generating unit 29 includes a scaling unit 31 and converts the onscreen scale to fit the size of the display unit 45. The onscreen signal according to the exemplary embodiment does not pass through the image quality adjusting unit 41 and thus does not undergo the image quality adjustment.

The pre-image combining unit 37 combines the image data output from the main decoding unit 17 and the image data output from the sub-decoding unit 23.

The combining is performed by α (alpha) blending. After the α-blending, image data in Y, Cb, Cr format, for example, is output. Note that, although the input image data contains the information of transparency, non-transparent data is output after the α-blending.

The image quality adjusting unit 41 performs processing such as γ-correction, sharpness, or matrix operations (to carry out tone correction, color level or brightness level correction etc.).

In the case of not using the output of the image quality adjustment function and the pre-image combining unit 37, the image combining unit 43 combines the output of the sub-decoding unit 23 and the onscreen from the onscreen generating unit 29. The combining is performed by the α-blending. The output data is in Y, Cb, Cr format, for example, and non-transparent data with no transparency is output to the display unit 45.

The path control unit is composed of a first switch 35, a second switch 33 and a third switch 39, and performs switching under control of the CPU 47 to decide the data path.

The first switch 35 selectively outputs the image data output from the sub-decoding unit 23 to one of the pre-image combining unit 37 and the image combining unit 43. The second switch 33 selectively outputs the image data output from the main decoding unit 17 to one of the pre-image combining unit 37 and the third switch 39. Further, the third switch 39 selectively outputs one of the output of the second switch 33 and the output of the pre-image combining unit 37 to the image quality adjusting unit 41.

Specifically, when there is a high probability that chroma key or luma key is contained in the input image data, the first switch 35 outputs the image data output from the sub-decoding unit 23 to the pre-image combining unit 37. The second switch 33 outputs the image data output from the main decoding unit 17 to the pre-image combining unit 37. The third switch 39 outputs the output of the pre-image combining unit 37 to the image quality adjusting unit 41. In this manner, when it is highly probable that chroma key or luma key is contained in the input image data, after the main video data and the sub-video data are combined together, the same image quality adjustment is performed on them.

On the other hand, when there is a low probability that chroma key or luma key is contained in the input image data, the first switch 35 outputs the image data output from the sub-decoding unit 23 to the image combining unit 43. The second switch 33 outputs the image data output from the main decoding unit 17 to the third switch 39. The third switch 39 outputs the image data from the second switch 33 to the image quality adjusting unit 41. In this manner, when it is less probable that chroma key or luma key is contained in the input image data, the image quality adjustment is performed only on the main video data, and then the main video data is combined with the sub-video data.

The CPU 47 determines whether there is a high probability that chroma key or luma key is contained in the input image data, and controls the switching of the first switch 35, the second switch 33 and the third switch 39 according to the determination result. In this exemplary embodiment, the CPU 47 makes the determination depending on the type of the input image data. It should be noted that, although the device that includes the antenna unit 11 and the receiving unit 13 and receives the digital terrestrial broadcast or the like, for example, is described in this exemplary embodiment, the input image data may be data from a DVD or a Blu-ray disc. The CPU 47 determines that chroma key or luma key is contained when the input image data is DVD data or data from a Blu-ray disc, and determines that chroma key or luma key is not contained when the input image data is received data of the digital terrestrial broadcast, and controls the switches based on such determination result. Further, when the image data received by the sub-decoding unit 23 is a still image, the CPU 47 may control the switches in the way that chroma key or luma key is not contained in the input image data.

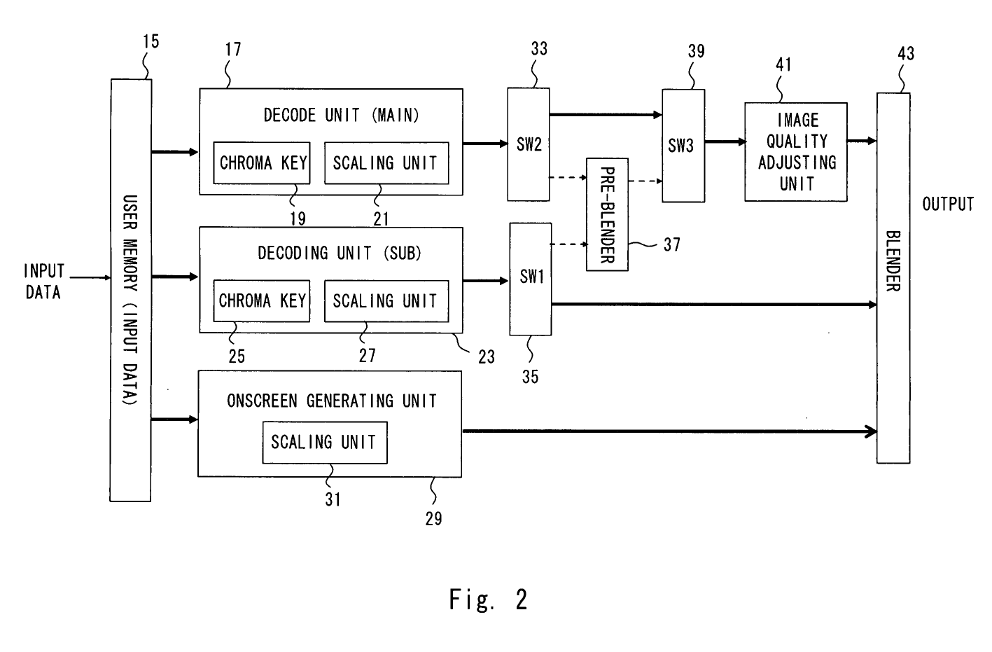

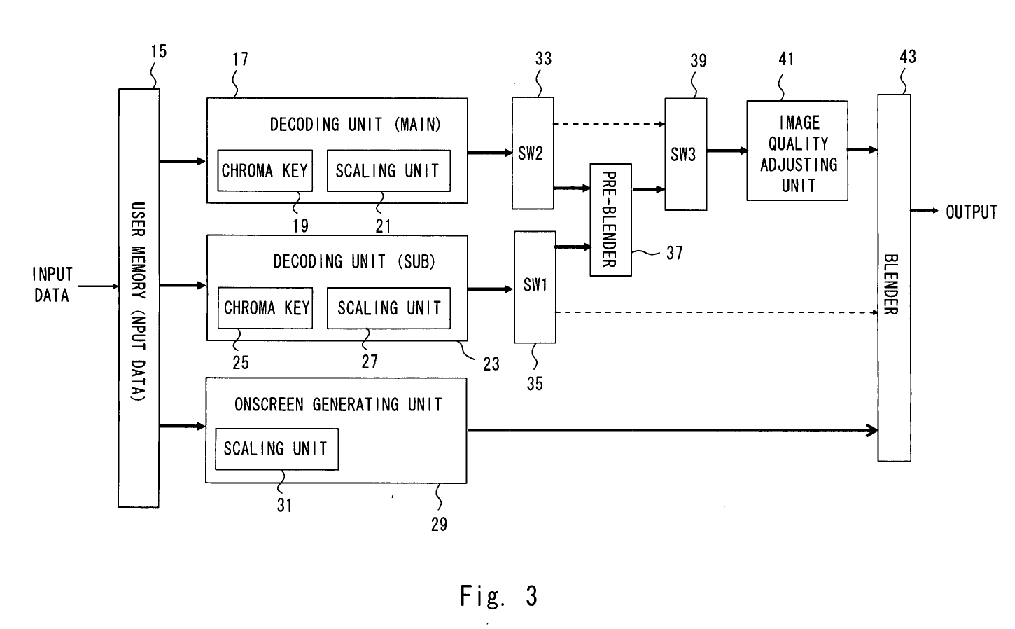

Hereinafter, the operation of the image processing device according to the exemplary embodiment is described. FIGS. 2 and 3 are a view showing a case of performing image processing only on main video data without combining main video data and sub-video data, and a case of performing image processing after combining, respectively.

Referring to FIG. 2, when the input image data is the digital terrestrial broadcast received data, for example, the first switch 35 supplies the sub-video data to the image combining unit 43. Further, the second switch 33 and the third switch 39 supply the main video data directly to the image quality adjusting unit 41. Accordingly, the main video data undergoes the image quality adjustment before being combined with the sub-video data. On the other hand, referring to FIG. 3, when the input image data is DVD data, data from a Blu-ray disc or the like, the first switch 35 supplies the sub-video data to the pre-image combining unit 37. Further, the second switch 33 outputs the main video data to the pre-image combining unit 37. The pre-image combining unit 37 thereby combines the main video data and the sub-video data before the image quality adjustment. After that, the combined image data is input to the image quality adjusting unit 41 through the third switch 39 and then undergoes the image quality adjustment. Note that the onscreen signal from the onscreen generating unit 29 is always directly input to the image combining unit 43 and never undergoes the image quality adjustment.

In this exemplary embodiment, in the case of a content that contains chroma key or luma key, the main decoding unit 17 and the sub-decoding unit 23 decode the chroma key or the luma key, and the first switch 35 and the second switch 33 are switched to select the pre-image combining unit 37, so that the main video data and the sub-video data are combined and then input to the image quality adjusting unit 41. The same image quality adjustment processing can be thereby performed on the main video data and the sub-video data. In the case of creating one video by combining the main video data and the sub-video data, for example, this prevents a boundary from appearing between a part created from the main video data and a part created from the sub-video data.

For example, in the case of combining the data in such a way that the main video data comes at the top and the sub-video data comes at the bottom, the area of the sub-video data at the bottom is revealed only in the part of the area of the main video data at the top which is made transparent by the chroma key decoding. If the image quality adjustment is performed in this state, the same image quality adjustment is made on the main video data and the sub-video data. In related art, the image quality adjustment is performed only on the main video data (moving image). However, there is a content in which the original pictures of the main video data and the sub-video data are identical, and a part of the main video data is removed by luma key and combined with the sub-video data. In this case, the output image is seemingly the same image as the one before combining. In the case where the output is expected to prevent a boundary from appearing in the image, if the image quality adjustment is performed only on the main video data according to related art, the boundary appears due to a difference in the effect of the image quality adjustment, thus failing to obtain the expected output. Further, although whether or not to carry out the image quality adjustment in the OSD is not restricted for an expected value of such a content (whether or not to perform the image quality adjustment in the OSD is not contained as the expected value of the content), in order to maintain the quality level of the OSD, it is necessary to take some measures to prevent the image quality adjustment from being performed in the OSD.

Further, for the content that does not contain chroma key or luma key, it is possible to perform the image quality adjustment only on the main video data. The identical image quality adjustment processing can be thereby performed on the sub-video data treated as a still image and the onscreen signal of a still image. Accordingly, a boundary does not appear when the onscreen signal and the sub-video data are just overlapping in a video. Note that the α-blending of the main video data and the sub-video data may be made in a semi-transparent state.

For example, to support chroma key in Hirata or the like, image quality adjusting circuits are placed for both of the main video data and the sub-video data, for example. However, the image quality adjusting circuit is large in size, thus causing an increase in cost. On the other hand, if the image quality adjustment is performed after combining all data including the onscreen signal, although the same image quality adjustment can be always made on the main video data and the sub-video data, the quality of the onscreen signal is degraded.

Further, in this exemplary embodiment, the image quality adjustment is never performed on the onscreen signal. The processing of the image quality adjusting unit 41 includes filtering involving horizontally and vertically adjacent pixels, for example. If the image quality adjustment including such filtering is performed, ringing (a phenomenon where an outline appears a multiple image) or burring (an outline is blurred and characters appear unclear) occurs around characters in the caption information categorized as the onscreen, which leads to the degradation of quality. The problem arises for the characters because pixels are fine and they are easily affected.

According to the exemplary embodiment, the path of image data can be switched by the path control unit with respect to each content, so that the image quality adjustment can be performed only when necessary according to the content. Further, because the data on which the image quality adjustment is not performed (the onscreen signal, or the onscreen signal and the sub-video data) is combined after performing the image quality adjustment only on the video data (only the main video data, or the main video data and the sub-video data, the image quality adjustment processing can be avoided for the onscreen and the sub-video data treated as an equivalent of the onscreen.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

For example, in the above exemplary embodiment, the data receiving device is explained as hardware. However, an arbitrary processing can be achieved by executing a program by CPU (Central Processing Unit). The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-RW (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

What is claimed is:

1. An image processing device comprising:
a main decoding unit that receives main data of input image data and decodes chroma key or luma key;
a sub-decoding unit that receives sub-data of the input image data and decodes chroma key or luma key;
a pre-image combining unit that combines image data decoded by the main decoding unit and the sub-decoding unit before image quality adjustment;
an image quality adjusting unit that performs image quality adjustment of image data output from the main decoding unit and composite image data output from the pre-image combining unit;
an image combining unit that combines image data after the image quality adjustment and image data output from the sub-decoding unit; and
a path control unit that controls a path of data so as to perform the image quality adjustment after combining the decoded main data and the decoded sub-data when there is a high probability that chroma key or luma key is contained in the input image data and to perform the image quality adjustment only on the decoded main data when there is a low probability that chroma key or luma key is contained in the input image data.

2. The image processing device according to claim 1, wherein
the path control unit includes a first switch, a second switch and a third switch that are controlled to switch based on a probability that chroma key or luma key is contained in the input image data,
the first switch selectively outputs the image data output from the sub-decoding unit to one of the pre-image combining unit and the image combining unit,
the second switch selectively outputs the image data output from the main decoding unit to one of the pre-image combining unit and the third switch, and
the third switch selectively outputs one of an output of the second switch and an output of the pre-image combining unit to the image quality adjusting unit.

3. The image processing device according to claim 2, wherein, when there is a high probability that chroma key or luma key is contained in the input image data,
the first switch outputs the image data output from the sub-decoding unit to the pre-image combining unit,
the second switch outputs the image data output from the main decoding unit to the pre-image combining unit, and
the third switch outputs the output of the pre-image combining unit to the image quality adjusting unit.

4. The image processing device according to claim 2, wherein, when there is a low probability that chroma key or luma key is contained in the input image data,
the first switch outputs the image data output from the sub-decoding unit to the image combining unit,
the second switch outputs the image data output from the main decoding unit to the third switch, and
the third switch outputs image data from the second switch to the image quality adjusting unit.

5. The image processing device according to claim 1, further comprising:
an onscreen generating unit that generates an onscreen signal from the input image data,
wherein the onscreen generating unit outputs the generated onscreen signal to the image combining unit.

6. The image processing device according to claim 1, further comprising:
a memory that stores the input image data.

7. The image processing device according to claim 6, further comprising:
a receiving unit that receives the input image data,
wherein the receiving unit decodes the main data or the sub-data from the received data and stores the decoded main data or the decoded sub-data into a given region of the memory.

8. The image processing device according to claim 1, further comprising:
a control unit that determines whether there is a high probability that chroma key or luma key is contained in the input image data,
wherein the control unit controls the path control unit according to a result of the determination.

9. The image processing device according to claim 8, wherein the control unit makes the determination depending on a type of the input image data.

10. The image processing device according to claim 8, wherein, when image data received by the sub-decoding unit is a still image, the control unit controls the path control unit in a way that chroma key or luma key is not contained in the input image data.

11. The image processing device according to claim 1, wherein the input image data having a high probability to contain chroma key or luma key is DVD (Digital Versatile Disc) data.

12. The image processing device according to claim 1, wherein the input image data having a low probability to contain chroma key or luma key is image data in data broadcasting.

13. The image processing device according to claim 1, wherein the main decoding unit and the sub-decoding unit perform scaling after decoding of chroma key or luma key or perform decoding of chroma key or luma key after scaling.

14. An image processing method comprising:
receiving main data and sub-data of input image data, decoding chroma key or luma key of the main data and the sub-data, and performing image quality adjustment after combining the decoded main data and the decoded sub-data when there is a high probability that chroma key or luma key is contained in the input image data; and
performing the image quality adjustment only on the main data of the input image data when there is a low probability that chroma key or luma key is contained in the input image data.

15. The image processing method according to claim 14, further comprising:
receiving onscreen data of the input image data and generating an onscreen; and
combining the onscreen with image data after the image quality adjustment.

16. The image processing method according to claim 14, further comprising:
determining whether there is a high probability that chroma key or luma key is contained in the input image data, and deciding whether to perform the image quality adjustment on image data after the combining or to perform the image quality adjustment only on the main data according to a result of the determination.

17. The image processing method according to claim 16, wherein the determination whether there is a high probability that chroma key or luma key is contained in the input image data is made depending on a type of the input image data.

18. The image processing method according to claim 16, wherein, when the sub-data is a still image, the image quality adjustment is performed only on the main data.

19. The image processing method according to claim 14, wherein the input image data having a high probability to contain chroma key or luma key is DVD (Digital Versatile Disc) data.

20. The image processing method according to claim 14, wherein the input image data having a low probability to contain chroma key or luma key is image data in data broadcasting.
